(19) United States
(12) Patent Application Publication
(10) Pub. No.: US 2013/0049342 A1
(43) Pub. Date: Feb. 28, 2013

(54) TRAILER CHASSIS HOLD DOWN SYSTEM

(71) Applicants: James Michael Cottrell, Fuquay-Varina, NC (US); Daniel Eric Tyrrell, Fuquay-Varina, NC (US)

(72) Inventors: James Michael Cottrell, Fuquay-Varina, NC (US); Daniel Eric Tyrrell, Fuquay-Varina, NC (US)

(21) Appl. No.: 13/595,998

(22) Filed: Aug. 27, 2012

Related U.S. Application Data
(60) Provisional application No. 61/527,190, filed on Aug. 25, 2011.

(51) Int. Cl. B60P 3/22

(52) U.S. Cl. 280/839

(57) ABSTRACT

An integrated trailer chassis hold down system/firefighting system can be used, among other purposes, to transport and deploy firefighting foam concentrate from intermediate bulk containers when supplied by a pressurized water source through foam eductors, self educting nozzles, or to resupply foam from a transfer pump for transportation. The trailer chassis can securely fasten intermediate bulk containers, keeping their center of gravity low for safe travel on highways and roads. The trailer chassis can cradle the intermediate bulk container with integrated hold down tabs bolded directly to the chassis. This hold down system allows the intermediate bulk container to sit inside the trailer chassis to keep the center of gravity low and allow the IBC to fit with close tolerance inside the chassis with positive restraint.

### CROSS-REFERENCE TO RELATED APPLICATION

This application claims the benefit of priority of U.S. provisional application No. 61/527,190, filed Aug. 25, 2011, the contents of which are herein incorporated by reference.

### BACKGROUND OF THE INVENTION

The present invention relates to a trailer chassis hold down system and, more particularly, to an integrated trailer chassis hold down system/firefighting system for securely fastening intermediate bulk containers (IBCs) to a trailer, keeping the center of gravity low for safe travel on highways and roads.

There are various systems for transporting intermediate bulk containers. Most systems simply dispose the IBC on a flat trailer, holding the IBC down with straps and/or chains, allowing them to shift in transit. Most of these systems sit high on the trailer or deck, raising the center of gravity of the trailer and reducing transport safety.

As can be seen, there is a need for an improved trailer chassis for transporting intermediate bulk containers.

### SUMMARY OF THE INVENTION

In one aspect of the present invention, a trailer comprises a trailer chassis; a cradle frame disposed on the trailer chassis to surround an outer perimeter of an intermediate bulk container disposed on the trailer; and a plurality of hold down tabs disposed to secure a pallet lower lip of the intermediate bulk container to the cradle frame.

In another aspect of the present invention, a trailer chassis comprises a cradle frame disposed on the trailer chassis to surround an outer perimeter of an intermediate bulk container disposed on the trailer; and a plurality of hold down tabs disposed to secure a pallet lower lip of the intermediate bulk container to the cradle frame, wherein the intermediate bulk container is disposed between wheels of the trailer.

In a further aspect of the present invention, a trailer comprises a trailer chassis; a cradle frame disposed on the trailer chassis to surround an outer perimeter of an intermediate bulk container disposed on the trailer; and a front pair of hold down tabs disposed on a front end of the cradle frame and a rear pair of hold down tabs disposed on a rear end of the cradle frame, the front pair and the rear pair of hold down tabs being disposed to secure a pallet lower lip of the intermediate bulk container to the cradle frame, wherein the intermediate bulk container is disposed between wheels of the trailer.

These and other features, aspects and advantages of the present invention will become better understood with reference to the following drawings, description and claims.

### BRIEF DESCRIPTION OF THE DRAWINGS

FIG. 1 is a perspective view of a trailer chassis securely holding an intermediate bulk container according to an exemplary embodiment of the present invention;

FIG. 2 is a side view of the trailer chassis and intermediate bulk container of FIG. 1;

FIG. 3 is a back view of the trailer chassis and intermediate bulk container of FIG. 1;

FIG. 4 is a cross-sectional view taken along line 4-4 of FIG. 1;

FIG. 5 is a detail cross-sectional view showing hold down tabs fitting against a pallet lower lip of the intermediate bulk container;

FIG. 6 is an exploded perspective view of the trailer chassis of FIG. 1;

FIG. 7 is a perspective view of an intermediate bulk container adapted to be securely carried by the trailer chassis of the present invention; and

FIG. 8 is a cross-sectional view taken along line 8-8 of FIG. 7.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an integrated trailer chassis hold down system/firefighting system to transport and deploy firefighting foam concentrate from intermediate bulk containers when supplied by a pressurized water source through foam eductors, self educting nozzles, or to resupply foam from a transfer pump for transportation. The trailer chassis can securely fasten intermediate bulk containers, keeping their center of gravity low for safe travel on highways and roads. The trailer chassis can cradle the intermediate bulk container with integrated hold down tabs bolded directly to the chassis. This hold down system allows the intermediate bulk container to sit inside the trailer chassis to keep the center of gravity low and allow the IBC to fit with close tolerance inside the chassis with positive restraint.

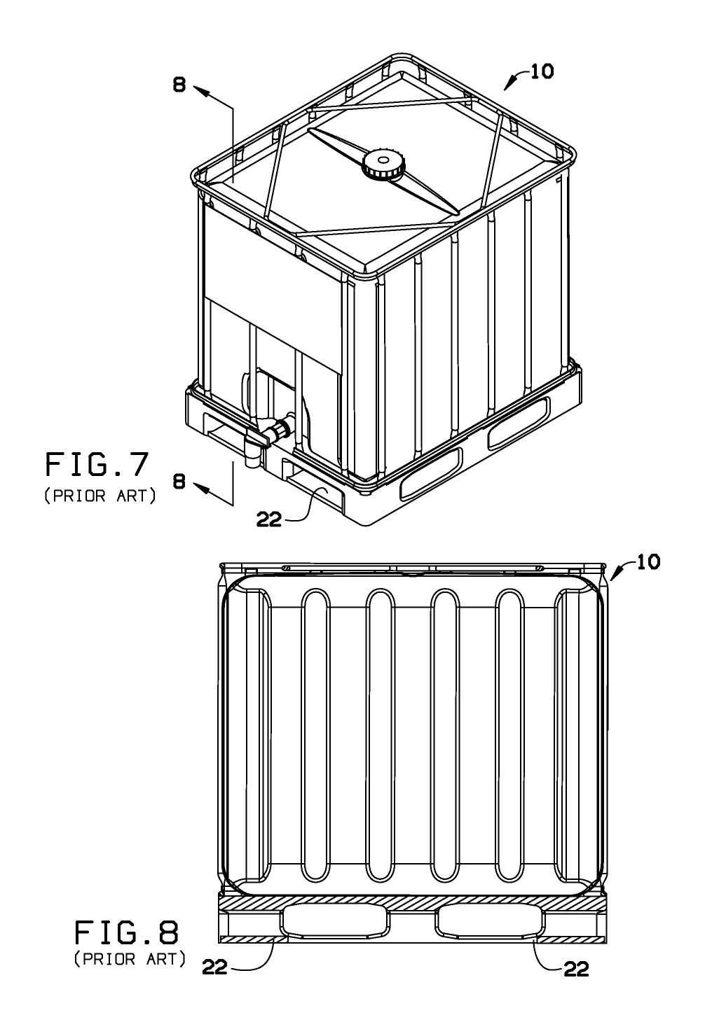

Referring to FIGS. 7 and 8, an intermediate bulk container 10 can be used to carry various materials, such as firefighting foam, agricultural liquids, petro chemicals, and the like. The IBC 10 can include a pallet lower lip 22 that forms a gap from the IBC 10 to allow forks to be inserted for moving the IBC 10.

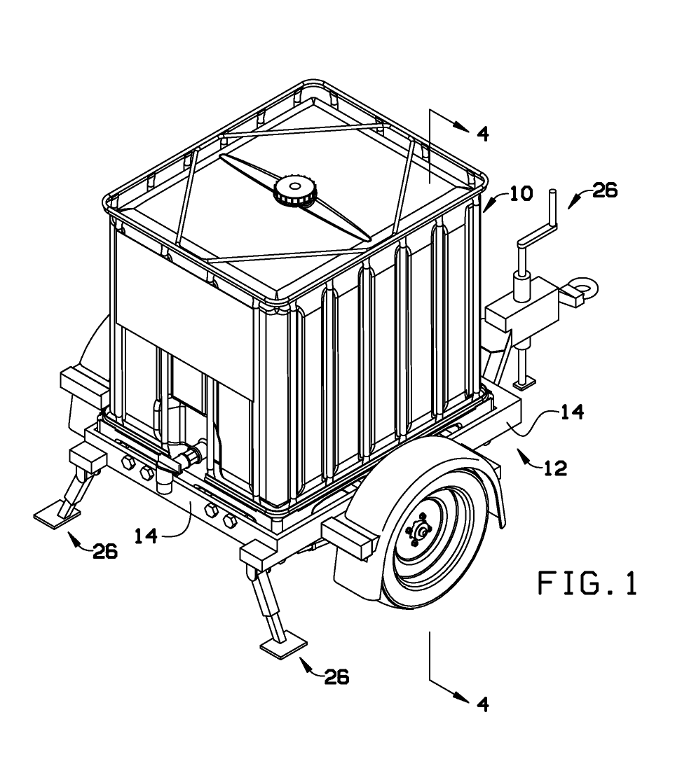

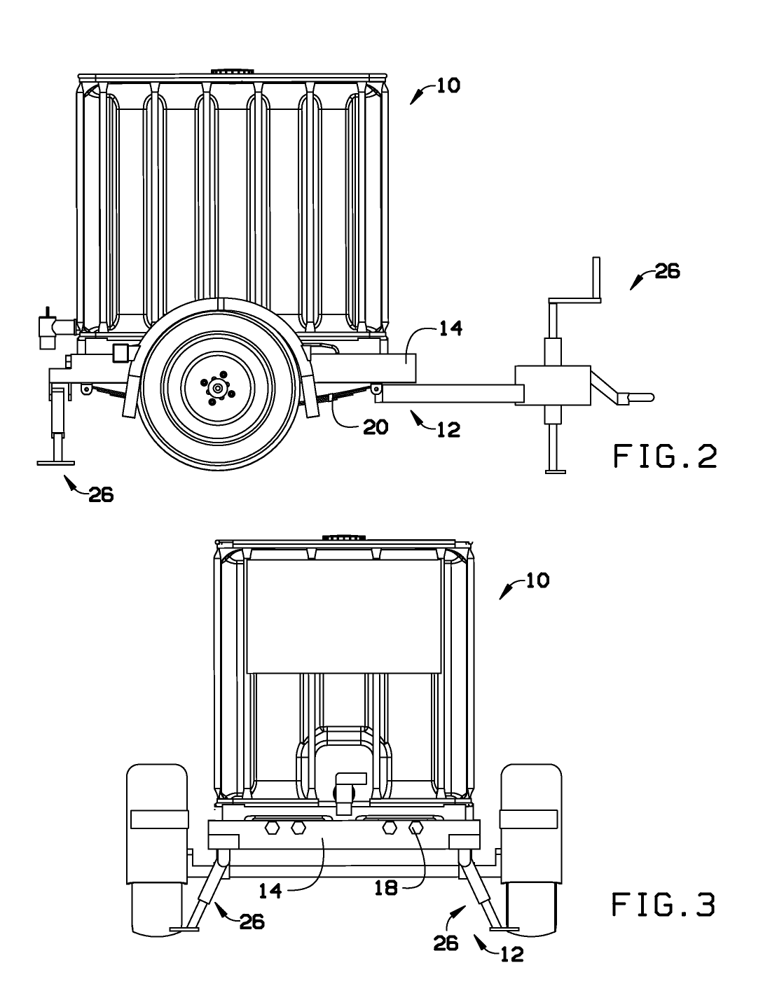

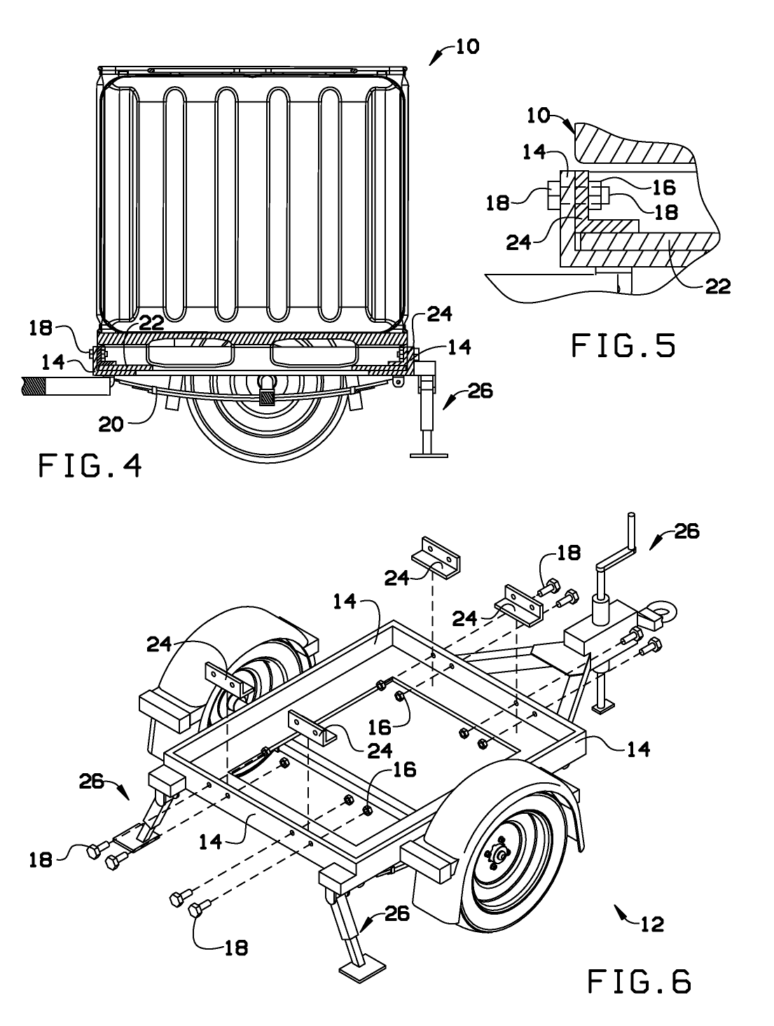

Referring now to FIGS. 1 through 6, a trailer chassis 12 can include a cradle frame 14 for surrounding the IBC 10 when disposed on the trailer chassis 12. The cradle frame 14 can keep the IBC 10 from shifting while being transported in the trailer chassis 12.

A hold down system can include a plurality of hold down tabs 24. The hold down tabs 24 can be secured to the cradle frame 14 with bolts 18 and nuts 16. Typically, the bolts 18 can be hardened, grade 8, ½ inch diameter bolts. The hold down tabs 24, in one embodiment of the present invention, can be about 2 inch long and about 3 inches wide and formed in an L-shape. The hold down tabs 24 can press against the pallet lower lip 22 and secure the IBC 10 on the trailer chassis 12. The hold down tabs 24 can be positioned at opposite ends, such as the front and rear ends, of the trailer chassis 12, with two hold down tabs 24 on each end.

The trailer chassis 12 can include a spring 20 to support the wheels to the cradle frame 14. The IBC 10 typically sits within a wheel well of the trailer chasses 12, thereby lowering the center of gravity of the IBC 10.

The trailer chassis 12 can include a forward jack stabilizer 26 attached to a trailer tong for towing the trailer. The forward jack stabilizer 26 can be a conventional jack stabilizer that is used to hold up the tong of the trailer.

The trailer chassis 12 can include rear jack stabilizers 26, typically disposed at opposite sides at a rear end of the trailer chassis 12. The rear jack stabilizers 26 can be adjustable in length and can be folded up for storage when the trailer is transported along roadways.

While the figures show a single IBC 10 disposed on the trailer chassis 12, the system can be sized to carry more than one IBC 10. For example, up to three IBCs 10 can be carried in a single, appropriately sized trailer chassis having the above described hold down system for each IBC 10.

It should be understood, of course, that the foregoing relates to exemplary embodiments of the invention and that modifications may be made without departing from the spirit and scope of the invention as set forth in the following claims.

What is claimed is:

1. A trailer comprising:
a trailer chassis;
a cradle frame disposed on the trailer chassis to surround an outer perimeter of an intermediate bulk container disposed on the trailer; and
a plurality of hold down tabs disposed to secure a pallet lower lip of the intermediate bulk container to the cradle frame.

2. The trailer of claim 1, wherein the intermediate bulk container is disposed between wheels of the trailer.

3. The trailer of claim 1, further comprising a front pair of hold down tabs disposed on a front end of the cradle frame and a rear pair of hold down tabs disposed on a rear end of the cradle frame.

4. The trailer of claim 1, further comprising a forward jack stabilizer operable to dispose a front end of the trailer away from ground.

5. The trailer of claim 1, further comprising at least one rear jack stabilizer operable to dispose a rear end of the trailer away from ground.

6. A trailer chassis comprising:
a cradle frame disposed on the trailer chassis to surround an outer perimeter of an intermediate bulk container disposed on the trailer; and
a plurality of hold down tabs disposed to secure a pallet lower lip of the intermediate bulk container to the cradle frame, wherein
the intermediate bulk container is disposed between wheels of the trailer.

7. The trailer chassis of claim 6, further comprising a front pair of hold down tabs disposed on a front end of the cradle frame and a rear pair of hold down tabs disposed on a rear end of the cradle frame.

8. The trailer chassis of claim 6, further comprising:
a forward jack stabilizer operable to dispose a front end of the trailer away from ground; and
at least one rear jack stabilizer operable to dispose a rear end of the trailer away from ground.

9. A trailer comprising:
a trailer chassis;
a cradle frame disposed on the trailer chassis to surround an outer perimeter of an intermediate bulk container disposed on the trailer; and
a front pair of hold down tabs disposed on a front end of the cradle frame and a rear pair of hold down tabs disposed on a rear end of the cradle frame, the front pair and the rear pair of hold down tabs being disposed to secure a pallet lower lip of the intermediate bulk container to the cradle frame, wherein
the intermediate bulk container is disposed between wheels of the trailer.

10. The trailer of claim 9, further comprising:
a forward jack stabilizer operable to dispose a front end of the trailer away from ground; and
at least one rear jack stabilizer operable to dispose a rear end of the trailer away from ground.
